(19) United States
(12) Patent Application Publication
(10) Pub. No.: US 2005/0085601 A1
(43) Pub. Date: Apr. 21, 2005

(54) Process for forming Ziegler-Natta catalyst for use in polyolefin production

(76) Inventors: Kayo Vizzini, Pasadena, TX (US); Steven D. Gray, Houston, TX (US)

Correspondence Address: David J. Alexander;Fina Technology, Inc., P.O. Box 674412, Houston, TX, 77267-4412, US

(21) Appl. No.: 10/685,643

(22) Filed: Oct. 15, 2003

(51) Int. Cl. C08F 4/02

(52) U.S. Cl. 526/124.3; 526/352; 502/103; 502/104; 502/115; 502/128

(57) ABSTRACT

The invention provides a process for forming a catalyst for use in the polymerization of olefins. This process comprises reacting a chlorinating agent with a magnesium alkoxide compound to form a magnesium-titanium-alkoxide adduct, followed by reacting the magnesium-titanium-alkoxide adduct with an alkylchloride compound, e.g., benzoyl chloride, to form a magnesium chloride support. The support is then reacted with titanium tetrachloride to form a highly active catalyst useful for the production of polyolefins.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

This invention generally relates to forming a Ziegler-Natta catalyst for use in the polymerization of olefins. More specifically, the invention relates to reacting an alkylchloride compound with a magnesium-titanium-alkoxide adduct to precipitate a magnesium chloride catalyst support.

### BACKGROUND OF THE INVENTION

Olefins, also called alkenes, are unsaturated hydrocarbons whose molecules contain one or more pairs of carbon atoms linked together by a double bond. When subjected to a polymerization process, olefins are converted to polyolefins, such as polyethylene and polypropylene. One commonly used polymerization process involves contacting the olefin monomer with a Ziegler-Natta catalyst system that includes a conventional Ziegler-Natta catalyst, a co-catalyst, and one or more electron donors. Examples of such catalyst systems are provided in U.S. Pat. Nos. 4,107,413; 4,294,721; 4,439,540; 4,114,319; 4,220,554; 4,460,701; 4,562,173; and 5,066,738, which are incorporated by reference herein.

Conventional Ziegler-Natta catalysts comprise a transition metal compound generally represented by the formula:
MR⁺_{X}
where M is a transition metal, R⁺ is a halogen or a hydrocarboxyl, and x is the valence of the transition metal. Typically, M is a group IVB metal such as titanium, chromium, or vanadium, and R⁺ is chlorine, bromine, or an alkoxy group. Common transition metal compounds are TiCl₄, TiBr₄, Ti(OC₂H₅)₃Cl, Ti(OC₃H₇)₂Cl₂, Ti(OC₆H₁₃)₂Cl₂, Ti(OC₂H₅)₂Br₂, and Ti(OC₁₂H₂₅)Cl₃. The transition metal compound is typically supported on an inert solid, e.g., magnesium chloride.

The properties of the polymerization catalyst affect the properties of the polymer formed using the catalyst. For example, polymer morphology typically depends upon catalyst morphology. Good polymer morphology includes uniformity of particle size and shape and an acceptably high bulk density. Furthermore, it is desirable to minimize the number of very small polymer particles (i.e., fines) to avoid plugging transfer or recycle lines. Very large particles also must be minimized to avoid formation of lumps and strings in the polymerization reactor.

Another polymer property affected by the type of catalyst used is the molecular weight distribution (MWD), which refers to the breadth of variation in the length of molecules in a given polymer resin. In polyethylene for example, narrowing the MWD can improve properties such as toughness, i.e., puncture, tensile, and impact performance. On the other hand, broad MWD can favor ease of processing and melt strength.

The present invention provides an improved process for forming a catalyst that can be used to produce polyolefins with desired properties. The catalyst formed in accordance with the present invention is highly active, and its morphology is satisfactory. Furthermore, polyolefin resins produced using the catalyst can have narrow molecular weight distributions and thus can be formed into useful enduse products.

### SUMMARY OF THE INVENTION

The present invention includes a process for forming a catalyst for use in the polymerization of olefins. This process comprises reacting a chlorinating agent with a magnesium alkoxide compound to form a magnesium-titanium-alkoxide adduct and reacting the magnesium-titanium-alkoxide adduct with an alkylchloride compound to form a magnesium chloride support. The support is then reacted with titanium tetrachloride (TiCl₄) to form a highly active catalyst useful for the production of polyolefins.

In one embodiment of the invention, the magnesium alkoxide compound is first formed by reacting butylethylmagnesium (BEM) with an alcohol generally represented by the formula ROH, where R is an alkyl group containing, e.g., about 1 to 20 carbon atoms. The magnesium alkoxide compound is then combined with a chlorinating agent generally represented by the formula:
TiClₙ(OR′)₄₋ₙ
where R′ is an alkyl, cycloalkyl, or aryl group, and n is from 1 to 3. A magnesium-titanium-alkoxide adduct is formed as a result of mixing the magnesium alkoxide compound and the chlorinating agent.

An alkylchloride compound is reacted with the magnesium-titanium-alkoxide adduct to form a magnesium chloride (MgCl₂) support and one or more by-products such as an ether and/or an alcohol. Subsequently, the MgCl₂ is treated with TiCl₄ to form a Ziegler-Natta catalyst supported by MgCl₂. Polyolefins produced using this catalyst have narrow molecular weight distributions and thus may be formed into end use articles such as barrier films, fibers, and pipes.

### DESCRIPTION OF THE DRAWINGS

The invention, together with further advantages thereof, may best be understood by reference to the following description taken in conjunction with the accompanying drawing in which:

FIG. 1 depicts the particle size distributions of the catalysts described in Comparative Examples 1-2 and Examples 1-2.

FIG. 2 depicts the particle size distributions of the catalysts described in Comparative Examples 1-2 and in Example 4.

FIG. 3 depicts catalyst yield as a function of the amount of PhCOCl used for Examples 4-10.

FIGS. 4-5 depict the particle size distributions of the catalysts formed in Examples 4-10.

FIG. 6 depicts average catalyst particle size (D₅₀) as a function of the amount of PhCOCl used for Examples 4-10.

FIG. 7 depicts the particle size distributions of the catalysts described in Comparative Examples 1-2 and in Examples 4 and 11.

FIG. 8 depicts the fluff particle size distributions of the polymer resins described in Comparative Examples 3-4 and in Example 12.

FIG. 9 depicts the fluff particle size distributions of the polymer resins described in Comparative Examples 3-4 and in Example 13.

FIG. 10 depicts the particle size distributions of the catalysts described in Example 14.

FIG. 11 depicts the particle size distributions of the catalysts described in Example 15.

### DETAILED DESCRIPTION OF EMBODIMENTS

According to an embodiment of the invention, a polyolefin polymerization catalyst is formed using a process comprising several reactions. First, a magnesium alkyl compound (i.e., Mg(R*)₂, where R* may be the same or different alkyl group having about 1 to 20 carbon atoms), such as BEM, is reacted with an alcohol to form a soluble magnesium alkoxide compound in accordance with the following reaction:
BEM+2ROH→Mg(OR)₂
where R is an alkyl group containing, e.g., about 1 to 20 carbon atoms. The alcohol represented by the formula ROH may be branched or non-branched. An example of a suitable alcohol is 2-ethylhexanol. Any suitable reaction conditions and addition sequence for converting the BEM and alcohol reactants to a magnesium alkoxide compound may be used. In one embodiment, the alcohol is added to a BEM solution to form a reaction mixture, which is maintained at ambient temperature and pressure. The reaction mixture is stirred for a period of time sufficient to form the soluble magnesium alkoxide compound.

The resulting magnesium alkoxide compound is mixed with a mild chlorinating agent to form a magnesium-titanium-alkoxide adduct in accordance with the following equation:
Mg(OR)₂+TiClₙ(OR′)₄₋ₙ→[Ti(OR′)₄₋ₙClₙ•Mg(OR)₂]ₘ

where R′ is an alkyl, cycloalkyl, or aryl group, n is from 1 to 3, and m is at least 1, and can be greater than 1. Desirably, n is 1. Reagents include TiClₙ(OR′)₄₋ₙ where R′=alkyl or aryl and n is 1, and alternately Ti(OⁱPr)₃Cl, where ⁱPr represents isopropyl. Any suitable conditions for forming the magnesium-titanium-alkoxide adduct may be employed for this process. In one embodiment, the process is carried out at ambient temperature and pressure. The reactants are mixed for a period of time sufficient to form the magnesium-titanium-alkoxide adduct. It is believed that the adduct forms because the magnesium-titanium-alkoxide compound is sterically hindered, making it difficult for the chloride atoms of the titanium compound to metathesize with the magnesium alkoxide ligands. In essence, the adduct is almost, but not completely converted to MgCl₂.

Subsequently, the magnesium-titanium-alkoxide adduct is mixed with an alkylchloride compound such that it converts to an MgCl₂ support. The reaction proceeds as follows:
[Ti(OR′)₄₋ₙClₙMg(OR)₂]ₘ+R″ClΔ“TiMgCl₂”+R″OR
where R″ is an alkyl group containing, e.g., about 2 to 18 carbon atoms and where “TiMgCl₂” represents titanium impregnated MgCl₂ support. While R″ may be branched or unbranched, it can be desirable in some embodiments to have R″ unbranched. Possible alkylchloride compounds include benzoyl chloride, chloromethyl ethyl ether, and t-butyl chloride, with benzoyl chloride being desirable in particular embodiments. The amount of alkylchloride added to the magnesium alkoxide adduct can be in excess of that required for the reaction. The ratio of the amount of benzoyl chloride to the amount of Mg (e.g., BEM) in the reaction mixture can range from about 1 to 20 (i.e., from about 1:1 ratio up to about 20:1 ratio), or from about 1 to 10, and it can be desirable to range from about 4 to 8. The reaction may be carried out at any suitable conditions for precipitating the magnesium chloride support. In an embodiment, the reactants are refluxed for a period of time sufficient to precipitate the MgCl₂ support. In embodiments employing t-butylchloride, the reactants can be heated during reflux. In embodiments employing benzoyl chloride or chloromethyl ethyl ether, the reactants can be at room temperature during reflux. One or more by-products such as an ether (shown in the above reaction) are also produced by the reaction. It is believed that the presence of Ti during the precipitation of the MgCl₂ plays a major role in producing a highly active catalyst.

After separating the MgCl₂ support from the reaction mixture, the support may be washed with, e.g., hexane, to remove any contaminants therefrom. The MgCl₂ support is then treated with TiCl₄ to form a catalyst slurry in accordance with the following equation:
“TiMgCl₂”+2TiCl₄→Catalyst

This treatment may be performed at any suitable conditions, e.g., at ambient temperature and pressure, for forming a catalyst slurry. The catalyst slurry is washed with, e.g., hexane, and then dried. The resulting catalyst may be pre-activated using an alkyl aluminum compound, such as triethylaluminum (TEAL), to prevent the catalyst from corroding the polymerization reactor. More specifically, titanium chlorides in the catalyst are converted to titanium alkyls when reacted with an alkyl aluminum compound. Otherwise, the titanium chlorides might be converted to HCl when exposed to moisture, resulting in the corrosion of the polymerization reactor.

### EXAMPLES

The invention having been generally described, the following examples are given as particular embodiments of the invention and to demonstrate the practice and advantages hereof. It is understood that the examples are given by way of illustration and are not intended to limit the specification or the claims to follow in any manner.

Unless otherwise stated, all experimental examples were conducted under an inert atmosphere using standard Schlenk techniques. Several catalysts (samples C-M) were prepared in accordance with the process of the present invention. In addition, two types of conventional catalysts referred to as sample A and sample B were prepared, wherein Sample B was prepared in accordance with U.S. Pat. No. 5,563,225, for comparison with the other catalyst samples. Many of the compounds required for the examples, i.e., 2-ethylhexanol, benzoyl chloride, n-butyl chloride, t-butyl chloride, chloromethyl ethyl ether, ClTi(OⁱPr)₃, and TiCl₄, were purchased from Aldrich Chemical Company and were used as received. A heptane solution containing 15.6 wt. % BEM and 0.04 wt. % Al was purchased from Akzo Nobel. The catalyst particle size distribution, including average particle size D₅₀, for all of the catalyst samples was determined using a Malvern Mastersizer, and all particle size distribution values given herein were calculated on a volume average basis.

Hexane was purchased from Phillips and passed through a 3A molecular sieve column, a F200 alumina column, and a column filled with BASF R3-11 copper catalyst at a rate of 12 mL/min. for purification. An Autoclave Engineer reactor was employed for the polymerization of ethylene in the presence of each of the catalyst samples. This reactor has a four liter capacity and is fitted with four mixing baffles having two opposed pitch propellers. Ethylene and hydrogen were introduced to the reactor while maintaining the reaction pressure using a dome loaded back pressure regulator and the reaction temperature using steam and cold water. Hexane was introduced to the reactor as a diluent. Unless otherwise indicated, polymerization was carried out under the conditions set forth in Table 3. The fluff particle size distribution based on mass for the resulting polyethylene was obtained via sieving analysis using a CSC Scientific Sieve Shaker. The percentage of fines is defined as the weight percentage of fluff particles smaller than 125 microns.

### Comparative Example 1

Comparative catalyst Sample A was prepared by charging a one-liter reactor with the heptane solution containing 15.6 wt. % BEM (70.83 g, 100 mmol). Next, 26.45 g (203 mmol) of 2-ethylhexanol was slowly added to the BEM-containing solution. The reaction mixture was stirred for one hour at ambient temperature. Next, 77.50 g (100 mmol) of 1.0 M hexane solution of ClTi(OiPr)₃ were slowly added to the above mixture. The reaction mixture was stirred for one hour at ambient temperature to form a [Mg(O-2-ethylhexyl)2ClTi(OiPr)3] adduct. Thereafter, hexane solution (250 mL) of a mixture of TNBT (34.04 g, 100 mol) and TiCl₄ (37.84 g, 200 mmol) were added to the resulting solution. The reaction mixture was stirred for one hour at ambient temperature to form a white precipitate. The precipitate was allowed to settle, and supernatant was decanted. The precipitate was washed three times with approximately 200 mL of hexane. The solid was re-slurried in approximately 150 mL of hexane and 50 mL of a hexane solution containing TiCl₄ (18.97 g, 100 mmol) was added. The slurry was allowed to stir for one hour at ambient temperature. The solid was allowed to settle, and the supernatant was decanted. The solid was washed once with 200 mL of hexane. About 150 mL of hexane was then added to the precipitate. The catalyst was treated again with 50 mL of a hexane solution containing TiCl₄ (18.97 g, 100 mmol). The slurry was stirred for one hour at ambient temperature. The solid was allowed to settle, and the supernatant was decanted. The catalyst was washed twice with 200 mL of hexane. About 150 ML of hexane was then added to the precipitate. The final catalyst was obtained by reacting with 7.16 g (15.6 mmol) of 25 wt % heptane solution of TEAL for one hour at ambient temperature.

### Comparative Example 2

Comparative catalyst Sample B was prepared by introducing 330 ml of 15 wt % heptane solution of dibutylmagnesium, 13.3 mL of 20 wt % pentane solution of tetraisobutylaluminoxane, 3 ml of diisoamyl ether, and 153 ml of hexane to a one liter flask. The mixture was stirred for 10 hours at 50° C. Next, 0.2 ml of TiCl₄ and the mixture of t-butylchride (96.4 mL) and DIAE (27.7 mL) were added. The mixture was stirred at 50° C. for 3 hours. The precipitate was settled and the supernatant was decanted. The solid was washed three times with hexane (100 mL) at room temperature. The solid was reslurried in 100 mL of hexane. Anhydrous HCl was introduced to the reaction mixture for 20 minutes. The solid was filtered and washed with 100 mL hexane twice. The solid was again suspended in hexane. 50 mL of pure TiCl₄ was added to the slurry and the mixture was stirred for two hours at 80° C. The supernatant was decanted and the catalyst was washed with 100 ml of hexane ten times. The catalyst was dried at 50 C under N₂ flow.

### Example 1

Catalyst sample C was prepared according to the present invention as follows: a three neck, 250 mL round bottom flask equipped with a dropping funnel, a septum and a condenser was charged with the heptane solution containing 15.6 wt. % BEM (17.71 g, 25 mmol). Next, 6.61 g (51 mmol) of 2-ethyl hexanol were slowly added to the BEM-containing solution, and the reaction mixture was stirred for one hour at ambient temperature. To this solution was next added 19.38 g (25 mmol) of ClTi(OiPr)₃ (1 M in hexanes). The reaction mixture was stirred for one hour at ambient temperature to form a [Mg(O-2-ethylhexyl)₂ClTi(OⁱPr)₃] adduct. Next, 18.51 g (200 mmol) of t-butyl chloride were added to the resulting solution such that the molar ratio of t-butyl chloride to BEM was about 8:1. The reaction mixture was heated for 24 hours at reflux temperature, i.e., about 80° C., to form a MgCl₂ precipitate (i.e., ensuing catalyst support). The white precipitate was allowed to settle, and the yellowish supernatant was decanted. The precipitate was washed three times with about 100 mL of hexane. About 100 mL of hexane was then added to the precipitate, followed by the slow addition of TiCl₄ (9.485 g, 50 mmol) to the resulting solution. The slurry was stirred for one hour at ambient temperature. The solid was allowed to settle, and the supernatant was decanted. The catalyst was washed four times with 50 mL of hexane.

### Example 2

The procedure of Example 1 was followed to form catalyst sample D, except that the rate of reaction was accelerated by adding a higher amount of t-butyl chloride to the flask. In particular, 37.02 g (400 mmol) of t-butyl chloride were added to the solution in the flask, and the solution was heated at 55° C. for twenty-four hours. The solution therefore contained a t-butyl chloride/BEM molar ratio of about 16:1 (16 equivalents to BEM). As expected, an increase in yield was observed for Example 2 as compared to Example 1.

Table 1 below provides the compositions of the catalysts formed in Comparative Examples 1 and 2 and Examples 1 and 2.

TABLE 1

| Catalyst | Mg | Ti | Al | Cl |
|---|---|---|---|---|
| Sample | (wt. %) | (wt. %) | (wt. %) | (wt. %) |
| A | 11.92 | 6.8 | 2.7 | 51.71 |
| B | 22.8 | 2.3 | — | 66.7 |
| C | 13.17 | 3.6 | 0.8 | 48.05 |
| D | 11.01 | 4.9 | — | 47.77 |

The amounts of Mg and Cl in the samples C and D were similar to those amounts in sample A. The amounts of Ti in samples C and D were between the amount of Ti in samples A and B.

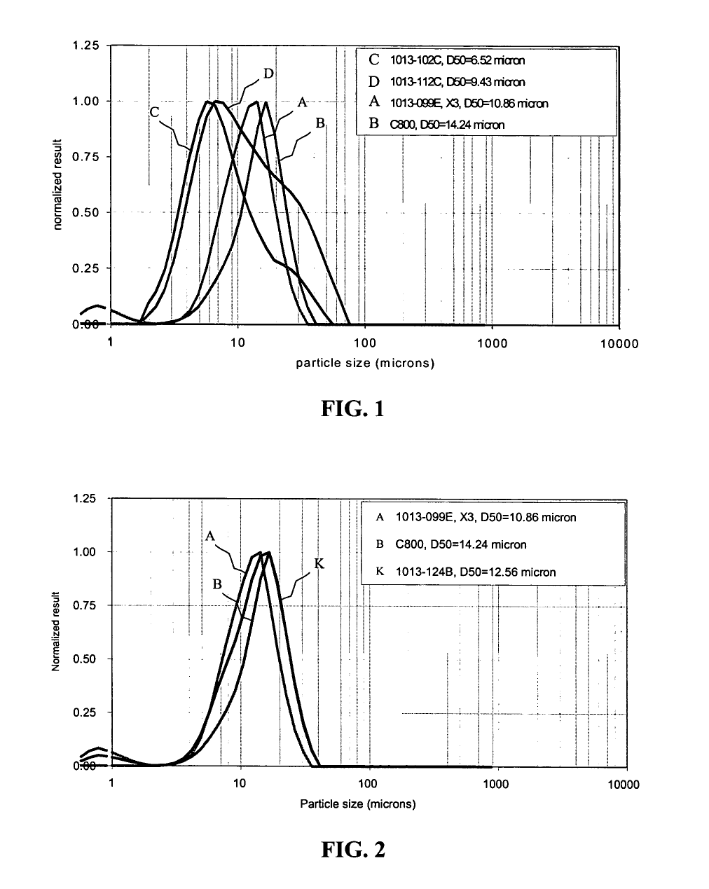

For Examples 1 and 2, the by-product of the reaction of Ti(OⁱPr)₃ClMg(OR)₂]ₙ with t-butyl chloride was examined by proton nuclear magnetic resonance (¹H NMR) and gas chromatography mass spectrometry (GCMS) analyses. It was found that the major by-product was 2-ethyl hexanol rather than the expected t-butyl 2-ethylhexyl ether or t-butyl-2-isopropyl ether. Based on this result, it is postulated that some reduction reaction might occur in the mixture, possibly forming isobutene that is removed from the reaction. FIG. 1 illustrates the particle size distributions of samples A-D. Both the sample A and B catalysts have narrow particle distributions. The average particle size of the sample B catalyst is slightly larger than that of sample A. The catalyst samples C and D prepared with t-butyl chloride have a broader bimodal distribution.

### Example 3

The procedure of Example 1 was followed except that a primary chloride, n-butyl chloride, was added to the flask instead of t-butyl chloride to form a solution having a n-butyl chloride/BEM molar ratio of about 16:1 (16 equivalents to BEM). Unfortunately, n-butyl chloride was not able to precipitate [Ti(OⁱPr)₃ClMg(OR)₂]ₙ after heating for 24 hours at 50° C. It is postulated that this observation suggests that the chlorination mechanism involves an dissociative elimination (El) step requiring a stable carbocation species.

### Example 4

Catalyst sample K was prepared as follows: A three-neck, 500 mL round bottom flask equipped with a dropping funnel, a septum, and a condenser was charged with a heptane solution containing 15.6 wt. % BEM (8.85 g, 12.5 mmol) and 100 mL of hexane. Next, 3.31 g (25 mmol) of 2-ethylhexanol were slowly added to the BEM-containing solution, and the reaction mixture was stirred for one hour at ambient temperature. Then 9.69 g (12.5 mmol) of ClTi(OiPr)₃ were slowly added to the above mixture, and the reaction mixture was stirred for one hour at ambient temperature. Next, 17.6 g (125 mmol) benzoyl chloride (PhCOCl) was added to the solution such that the molar ratio of PhCOCl to BEM was about 10:1 (10 equivalents to BEM). The reaction mixture was stirred for two hours at ambient temperature to form a MgCl₂ precipitate. The white precipitate was allowed to settle, and the supernatant was decanted. The precipitate was washed with 100 mL of hexane for three times. Thereafter, 100 mL of hexane was added to the precipitate, and TiCl₄ (4.25 g, 25 mmol) was then slowly added to the solution. The resulting slurry was stirred for one hour at ambient temperature. The yellowish solid was allowed to settle, and the yellow supernatant was decanted. The catalyst was washed three times with 50 mL of hexane.

Notably, the reaction for forming the MgCl₂ support from PhCOCl did not require heating as did the reaction with t-butyl chloride. Also, as shown in FIG. 2, the particle size distribution of catalyst sample K formed using PhCOCl was comparable to the particle size distributions of catalyst samples A and B.

### Examples 5-10

The procedure of Example 4 was followed to prepare six more samples (samples E-J), except that the amount of PhCOCl was varied each time such that the molar equivalence to BEM ranged from 1.2 to 7.2.

FIG. 3 shows catalyst yield as a function of the amount of PhCOCl used in Examples 4-10. The catalyst yield first increased as the PhCOCl concentration was increased and then became constant at an equivalent of about 7.0, achieving a maximum yield of about 1.7 g. Table 2 below provides the compositions of the catalysts formed in Examples 4-10.

TABLE 2

| Catalyst | Equiv. of | Ti | Al | Mg | Cl |
|---|---|---|---|---|---|
| Sample | PhCOCl | (wt %) | (wt %) | (wt %) | (wt %) |
| E | 1.2 | 5.0 | <0.2 | 13.02 | 51.34 |
| F | 2.4 | 3.8 | <0.2 | 12.55 | 47.55 |
| G | 3.6 | 3.1 | <0.2 | 12.47 | 40.24 |
| H | 4.8 | 2.7 | <0.2 | 12.48 | 41.07 |
| I | 6.0 | 2.6 | <0.2 | 12.39 | 43.02 |
| J | 7.2 | 2.6 | <0.2 | 10.87 | 43.03 |
| K | 10 | 2.6 | <0.2 | 11.30 | 42.35 |
| A | — | 6.8 | 2.7 | 11.92 | 51.71 |
| B | — | 2.3 | — | 22.8 | 66.7 |

As shown in Table 2, the titanium content decreased with increasing PhCOCl concentration up to 6.0 equivalents and remained constant at higher equivalents. The Ti content of catalyst samples H-K was similar to that of the catalyst sample B and lower than that of catalyst sample A. A possible explanation for this decrease in titanium amount may involve the benzoyl ester product or unreacted PhCOCl. NMR and GCMS analyses confirmed that the major by-products of the chlorination reaction are 2-ethylhexyl benzoate and isopropyl benzoate. These esters and the unreacted PhCOCl, all Lewis bases, are capable of complexing with electron-deficient titanium or magnesium. It is believed that the formation of such a complex would permit more extraction of titanium from the support. It is also believed that a complex with the MgCl₂ support would prevent epitaxial placement of TiCl₄ in the subsequent titanation. It is interesting that the titanium level becomes constant above seven equivalents of PhCOCl. This value corresponds to chlorination of all ClTi(OⁱPr)₃ and Mg(OR)₂. Above this amount of PhCOCl, the amount of esters is also constant, suggesting that the esters play an important role in determining the amount of titanium in the final catalyst.

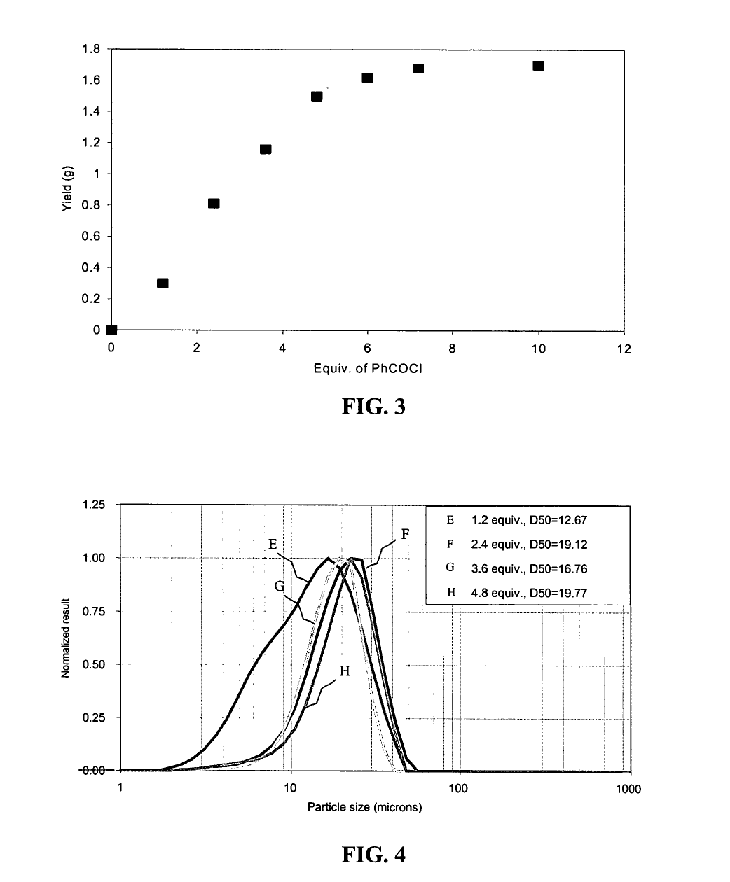

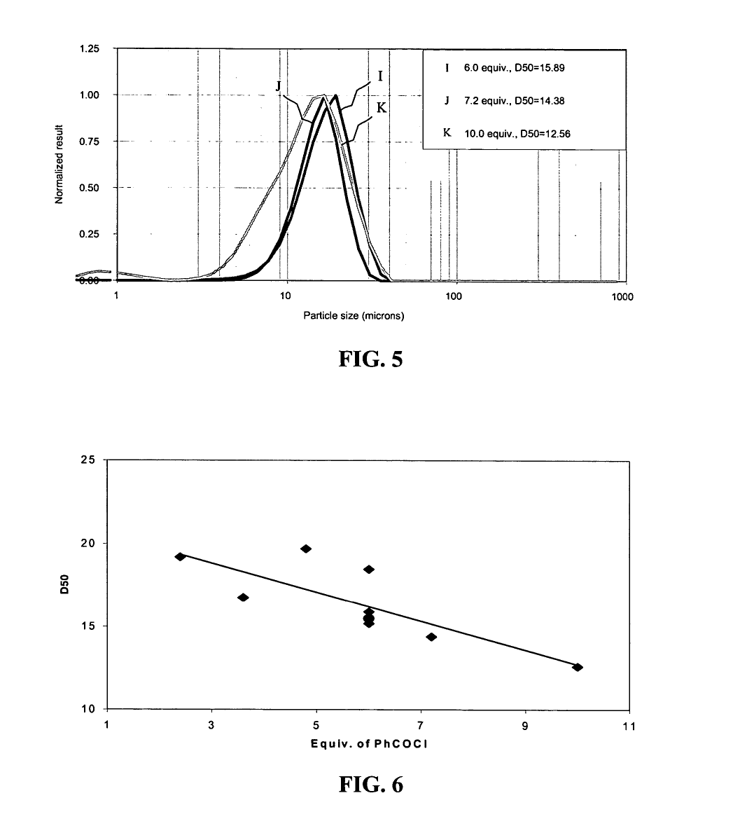

The particle size distributions of catalyst samples E-H and I-K, which were formed using different concentrations of PhCOCl, are illustrated in FIGS. 4 and 5, respectively. Sample E, which was formed from the lowest concentration of PhCOCl (1.2 equivalents to BEM), exhibited a broad bimodal distribution. Increasing the levels of PhCOCl produced catalysts with narrower unimodal distributions and thus improved catalyst morphology. Further, as shown in FIG. 6, the average particle size (D5o) decreased slightly with increasing PhCOCl concentration. It is postulated that both the PhCOCl and the ester products are capable of complexing with the unsaturated magnesium sites on the developing MgCl₂ support. As described above, these Lewis bases could aid in the extraction of titanium from the developing support. As such, it is believed that the dynamics of the support formation would be altered by the absence of the titanium complex.

### Example 11

Catalyst sample L was prepared as follows: A three-neck, 250 mL round bottom flask equipped with a dropping funnel, a septum, and a condenser was charged with a heptane solution containing 15.6 wt. % BEM (4.43 g, 6.25 mmol) and with 30 mL of hexane (30 mL). Then, 1.66 g (12.5 mmols) of 2-ethyl hexanol were slowly added to the BEM-containing solution, and the reaction mixture was stirred for one hour at ambient temperature. Thereafter, a solution of ClTi(OⁱPr)₃ (1 M in hexanes, 4.85 g, 6.25 mmol) was slowly added to the above mixture, and the reaction mixture was stirred for one hour at ambient temperature. A hexane solution (25 mL) containing chloromethyl ethyl ether (CMEE) (9.45 g, 100 mmols in) was then added to the solution such that the molar ratio of CMEE to BEM was about 8:1 (8 equivalents to BEM). The reaction mixture was stirred for one hour at ambient temperature, resulting in the formation of a MgCl₂ precipitate. The white precipitate was allowed to settle and the supernatant was decanted. The precipitate was washed three times with 50 mL of hexane. Then 30 mL of hexane was added to the precipitate, followed by slowly adding a hexane solution (30 mL) of TiCl₄ (2.13 g, 125 mmol) to the solution. The resulting slurry was stirred for one hour at ambient temperature. The yellowish solid was allowed to settle, and the yellow supernatant was decanted. The catalyst was subsequently washed with 50 mL of hexane for three times.

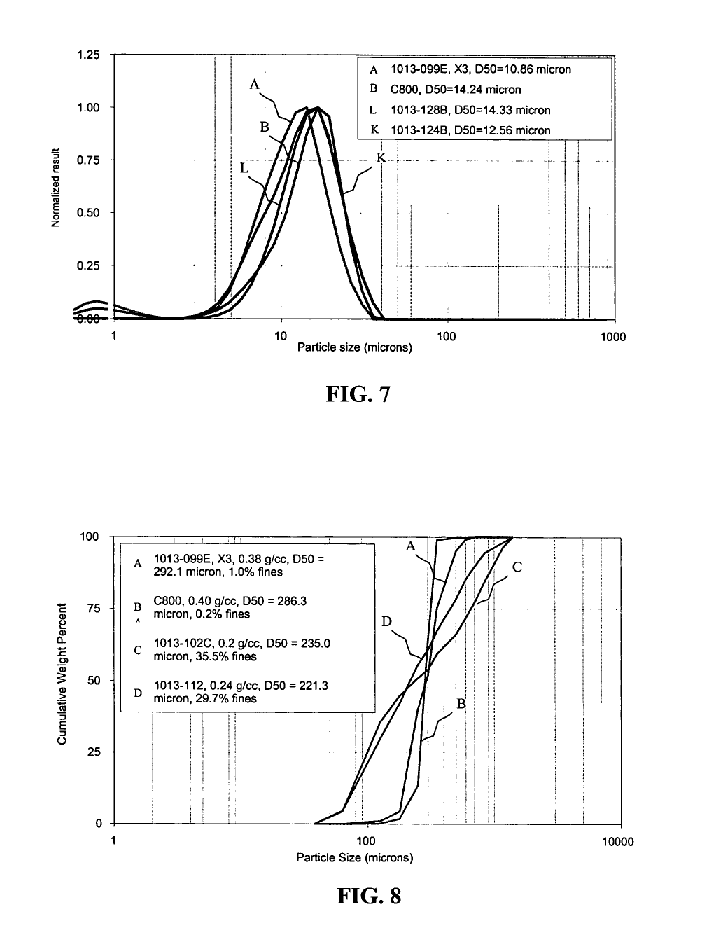

FIG. 7 depicts the particle size distributions of the CMEE-based catalyst sample L, the PhCOCl-based catalyst sample K, and catalyst samples A and B. The CMEE-based catalyst sample has a slightly broader particle size distribution than does the sample A, sample B, and the PhCOCl-based catalyst sample K. The particle size distribution of the CMEE-based catalyst has a shoulder of about 7 microns.

### Comparative Example 3

Ethylene was polymerized in the presence of catalyst sample A and a TEAL co-catalyst under the conditions set forth in Table 3.

### Comparative Example 4

Ethylene was polymerized in the presence of catalyst sample B and a TEAL co-catalyst under the conditions set forth in Table 3.

### Example 12

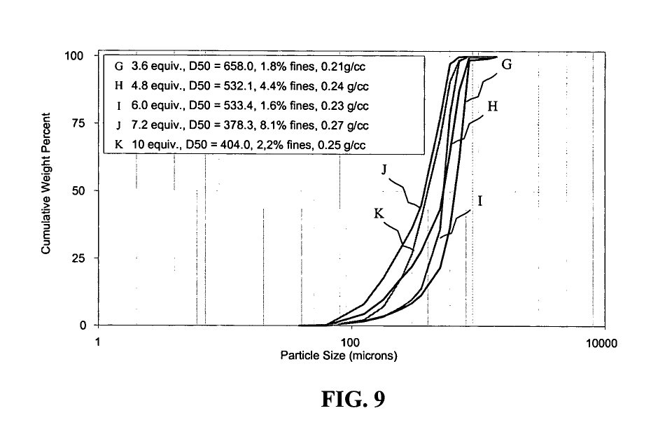

Ethylene was polymerized using the catalyst sample C and D prepared with t-butyl chloride under conditions set forth in Table 3. FIG. 8 illustrates the fluff particle size distributions of the polymers prepared in Example 12 and in Comparative Examples 3 and 4. The particle size distributions obtained using catalyst samples C and D are very broad. In contrast, the distributions obtained from catalyst samples A and B are relatively narrow. The fluff made from samples C and D contained more fines than did the fluff made from samples A and B. The fluff made from samples C and D also had a relatively low bulk density.

TABLE 3

| | |
|---|---|
| Diluent | Hexane |
| Temperature (° C.) | 80 |
| H₂/C₂ | 2/8 |
| Pressure (psig) | 125 |
| Co-catalyst | TEAL (0.75 mmol/L) |

Table 4 below provides the properties of the polymer resins produced using catalyst samples A, B, C, and D.

TABLE 4

| | | | Melt | | | | |
|---|---|---|---|---|---|---|---|
| Cata- | | | Index, | Melt | | | |
| lyst | Mg | Resin | 2.1 kg | Index, | SR₂ | SR₅ | |
| Sam- | Based | Density | (dg/ | 5.0 kg | (HLMI/ | (HLMI/ | Wax |
| ple | Activity | (g/cc) | min) | (dg/min) | MI₂) | MI₅) | (%) |
| A | 20,694 | 0.9647 | 3.75 | 12.06 | 35.6 | 11.1 | 1.4 |
| B | 10,000 | 0.9584 | 0.47 | 1.4 | 29.5 | 10.2 | 1.3 |
| C | 18,766 | 0.9574 | 0.59 | 1.6 | 28.1 | 10.3 | 0.7 |
| D | 41,390 | 0.9578 | 1.06 | 3.2 | 30.0 | 9.8 | 0.6 |

The magnesium-based activity of each catalyst sample was determined by first dissolving the catalyst and the polymer formed therefrom in acid to extract the remaining Mg. Catalyst activity was determined based on residual Mg content. As shown in Table 4, the Mg based activity of catalyst sample C was slightly lower than that of catalyst sample A and higher than that of catalyst sample B. The activity of catalyst sample D was higher than the activities of catalyst samples A and B. The shear responses of the polymers produced using the catalyst samples were calculated by finding the ratio of the high load melt index (HLMI) to the melt index. The shear responses of the polymers produced from catalysts samples C and D were similar to the shear responses of the sample B polymer but slightly lower than the shear responses of the sample A polymer. The amount of wax produced was comparable for all polymers.

### Example 13

Ethylene was polymerized using catalyst samples E-K prepared using benzoyl chloride under the conditions set forth in Table 3. FIG. 9 illustrates the fluff particle size distributions of the polymers prepared in this example (samples G-K). The average particle sizes (D₅₀) of the PhPOCl based resins were large compared to those of the sample A and sample B resins.

Table 5 below compares the morphologies of the PhPOCl catalyst samples to the morphologies of the polymers formed using the PhPOCl catalyst samples.

TABLE 5

| | | | | | Polymer | |
|---|---|---|---|---|---|---|
| | | | | | Morphology | |
| | Catalyst Morphology | | | | D₅₀ | |
| Catalyst | D10 | D50 | D90 | | (Mi- | Fines |
| Sample | (microns) | (microns) | (microns) | D90 − D10 | cron) | (%) |
| F | 10.08 | 19.12 | 30.94 | 20.86 | 617.9 | 4.6 |
| G | 9.87 | 16.76 | 24.89 | 15.02 | 658.0 | 1.8 |
| H | 10.37 | 19.77 | 30.42 | 20.05 | 532.1 | 4.4 |
| I | 9.58 | 15.89 | 23.39 | 13.81 | 533.4 | 1.7 |
| J | 9.32 | 14.38 | 20.35 | 11.03 | 378.3 | 8.1 |
| K | 5.74 | 12.56 | 21.74 | 16.00 | 404 | 2.2 |
| A | 5.29 | 10.85 | 18.32 | 13.03 | 292 | 1.0 |
| B | 7.26 | 14.24 | 22.67 | 15.14 | 286 | 0.2 |

Based on the replication theory, polymer morphology can be related to catalyst morphology. However, the polymer morphology does not appear to correspond (i.e., are not proportional) to the catalyst morphology for samples F-K, whereas such appears to correspond for samples A and B.

Table 6 below provides the properties of the polymers produced using the PhPOCl catalyst samples (samples E-K) and catalyst samples A and B.

TABLE 6

| | | | Melt | | | | |
|---|---|---|---|---|---|---|---|
| | | | Index, | Melt | | | |
| | Mg | Resin | 2.16 kg | Index, | SR₂ | SR₅ | |
| Cata- | Based | Density | (dg/ | 5.0 kg | (HLMI/ | (HLMI/ | Wax |
| lyst | Activity | (g/cc) | min) | (dg/min) | MI₂) | MI₅) | (%) |
| E | 39000 | 0.9669 | 8.97 | 29.25 | 32.0 | 9.8 | 0.8 |
| F | 40000 | 0.9633 | 3.42 | 10.39 | 30.1 | 9.9 | 0.2 |
| G | 37000 | 0.9633 | 4.32 | 13.05 | 30.4 | 10.1 | 0.3 |
| H | 25000 | 0.9636 | 2.33 | 6.60 | 27.8 | 9.8 | 0.3 |
| I | 26000 | 0.9626 | 2.90 | 10.89 | 37.7 | 10.0 | 0.2 |
| J | 25000 | 0.9636 | 4.90 | 14.48 | 28.5 | 9.6 | 0.3 |
| K | 38000 | 0.9601 | 1.51 | 4.16 | 29.2 | 10.6 | 0.5 |
| A | 20694 | 0.9647 | 3.75 | 12.06 | 35.6 | 11.1 | 1.4 |
| B | 10000 | 0.9584 | 0.47 | 1.4 | 29.5 | 10.2 | 1.3 |

The Mg-based activities of the samples E-K are higher than the activities of samples A and B. The activity generally decreased as the equivalents of PhCOCl was increased with the exception of sample K, which has an equivalence of 10. The densities of the sample E-K polymers were similar to those of the sample A and B polymers. The melt flow rates (i.e., melt indexes) of the sample E-K polymers and the sample A polymer were higher than those of the sample B polymer. The shear responses of the samples E-K polymers were similar to those of the sample B polymer but slightly lower than those of the sample A polymer. The amount of wax produced was comparable for all polymers.

### Example 14

As described previously, the PhCOCl-based catalyst sample I (hereafter known as “sample I₁”) was prepared by washing the MgCl₂ precipitate with hexane. This example compares catalyst sample I₁ to another catalyst sample I₂ that was prepared in the same manner as sample I₁ minus the washing step. It is believed that the elimination of the washing step could provide significant time and cost reduction in the catalyst production. Table 7 below shows the catalyst compositions of samples I₁ and I₂.

TABLE 7

| | | Equiv. of | Ti | Al | Mg | Cl |
|---|---|---|---|---|---|---|
| Catalyst | Washed | PhCOCl | (wt. %) | (wt. %) | (wt. %) | (wt. %) |
| I₁ | Yes | 6 | 2.6 | <0.2 | 12.39 | 43.02 |
| I₂ | No | 6 | 1.8 | <0.2 | 11.78 | 38.21 |

Eliminating the washing step resulted in approximately a 30% reduction in titanium level. The washed catalyst sample I₁ appeared light yellow in color. A yellow color was also evident in the unwashed catalyst sample 12 during the addition of the TiCl₄. However, as the TiCl₄ contacted the mother liquor, it immediately became colorless. It is postulated that the complex of ester with TiCl₄ may produce the yellow color, whereas PhCOCl may react with the TiCl₄ to form a colorless compound. This observation supports the earlier discussion on the dependence of titanium level on the PhCOCl amount. It is believed that excess PhCOCl and ester, if not removed, will complex with both the TiCl₂ and the support surface, preventing deposition of titanium on the support surface.

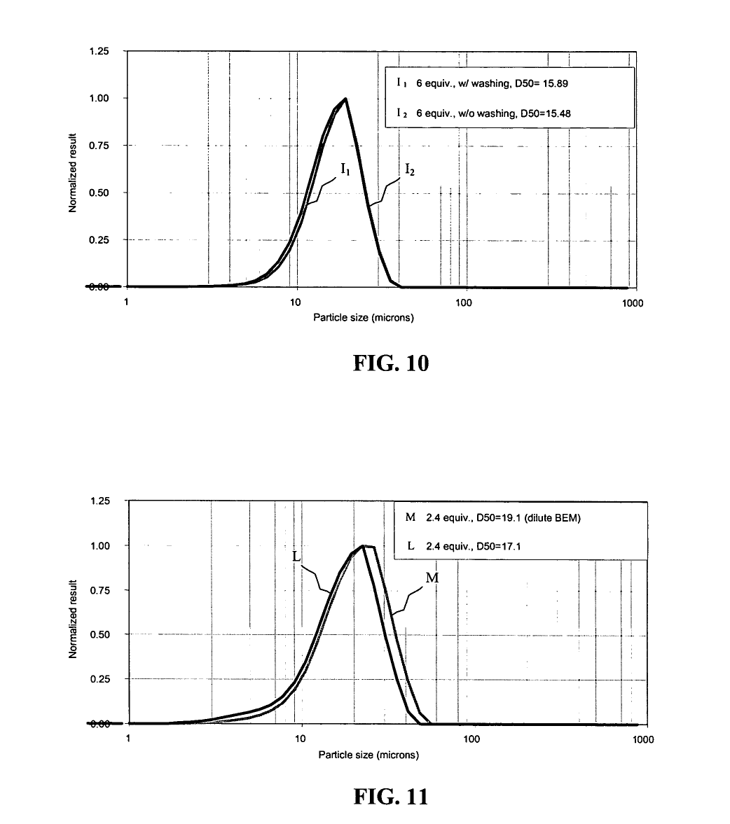

As shown in FIG. 10, the particle size distributions of samples I₁ and I₂ were almost identical. Therefore, the catalyst particle size distribution was unaffected by the washing step. This observation is not surprising since the washing step was performed after formation of the MgCl₂ support. Both samples I₁ and I₂ were used to polymerize ethylene. Table 8 below provides the catalyst and polymer morphologies for samples I₁ and I₂.

TABLE 8

| | | | | | Polymer | |
|---|---|---|---|---|---|---|
| | | | | | Morphology | |
| | Catalyst Morphology | | | | D₅₀ | |
| Washing | D₁₀ | D₅₀ | D₉₀ | | (Mi- | Fine |
| Step? | (Micron) | (Micron) | (Micron) | D₉₀ − D₁₀ | cron) | (%) |
| Yes | 9.58 | 15.89 | 23.39 | 13.81 | 533.4 | 1.7 |
| No | 9.21 | 15.48 | 23.02 | 13.81 | 239.2 | 23.7 |

Table 8 further supports the conclusion that particle size distribution is unaffected by the washing step. The number of fines formed in the polymer increased significantly when the washing step was eliminated. This increase in fines may have been due to lower productivity. The properties of the polymers formed using catalyst samples I₁ and I₂ are shown in Table 9 below.

TABLE 9

| | | | | Melt | Melt | | | |
|---|---|---|---|---|---|---|---|---|
| | Mg | Bulk | Resin | Index | Index | SR₂ | SR₅ | |
| Washing | Based | Density | Density | 2.16 kg | 5.0 kg | (HLMI/ | (HLMI/ | Wax |
| Step | Activity | (g/cc) | (g/cc) | (dg/min) | (dg/min) | MI₂) | MI₅) | (%) |
| Yes | 26000 | 0.23 | 0.9626 | 2.90 | 10.89 | 37.7 | 10.0 | 0.2 |
| No | 14800 | 0.29 | 0.9557 | 0.48 | 1.36 | 24.8 | 8.8 | 0.1 |

As depicted in Table 9, the polymerization activity of the unwashed catalyst was almost half that of the washed catalyst. The densities of the two polymers were almost the same. The shear response data, however, indicates that the unwashed catalyst had a narrower molecular weight distribution than the washed catalyst. It is believed that the presence of the PhCOCl and ester in the catalyst affects the active site distribution in the catalyst.

### Example 15

The effect of the BEM concentration on the catalyst properties was also studied. A first PhCOCl-based catalyst sample (sample L) was prepared using a BEM solution diluted with 100 mL of hexane. For comparison purposes, a second PhCOCL-based catalyst sample (sample M) was prepared using a BEM solution diluted with 20 mL of hexane. FIG. 11 shows the catalyst particle size distributions of catalyst samples L and M. The distributions of both catalysts are very similar. The compositions and properties of catalyst samples L and M and polymers made therefrom are presented below in Tables 10 and 11, respectively.

TABLE 10

| Catalyst | Yield | Ti | Al | Mg | Cl |
|---|---|---|---|---|---|
| Sample | (g) | (wt. %) | (wt. %) | (wt. %) | (wt. %) |
| L | 0.86 | 3.5 | <0.2 | 12.34 | 43.23 |
| M | 0.81 | 3.8 | <0.2 | 12.55 | 47.55 |

TABLE 11

| | | | Melt | | | | |
|---|---|---|---|---|---|---|---|
| Cata- | | | Index, | Melt | | | |
| lyst | Mg | Resin | 2.16 kg | Index, | SR₂ | SR₅ | |
| Sam- | Based | Density | (dg/ | 5 kg | (HLMI/ | (HLMI/ | Wax |
| ple | Activity | (g/cc) | min) | (dg/min) | MI₂) | MI₅) | (%) |
| L | 40000 | 0.9609 | 2.07 | 6.19 | 28.0 | 9.4 | 0.3 |
| M | 40000 | 0.9633 | 3.42 | 10.39 | 30.1 | 9.9 | 0.2 |

Tables 10 and 11 show that there is essentially no effect of BEM concentration on the catalyst composition and polymer properties.

In conclusion, new catalysts were synthesized using alkylchlorides such as n-butyl chloride, t-butyl chloride, and chloromethyl ethyl ether. Benzoyl chloride and chloromethyl ethyl ether formed catalysts with satisfactory particle size distributions whereas t-butyl chloride resulted in a bimodal distribution and n-butyl chloride failed to form MgCl₂. The catalyst preparation was optimized by varying the amount of benzoyl chloride added to the magnesium alkoxide adduct. As expected, the catalyst yield increased with increasing amounts of benzoyl chloride and became saturated at approximately seven equivalents of benzoyl chloride relative to BEM. The catalyst particle size distributions became narrower as the amount of benzoyl chloride was increased.

An experiment was also performed to observe the effect of eliminating the washing step after the support formation. The unwashed catalyst sample exhibited a lower activity and a lower shear response than did the washed catalyst. The effect of the BEM concentration on the catalyst properties was also examined. The particle size distribution, catalyst composition, and polymer properties were unaffected by the BEM concentration.

While embodiments of the invention have been shown and described, modifications thereof can be made by one skilled in the art without departing from the spirit and teachings of the invention. The embodiments described herein are exemplary only, and are not intended to be limiting. Where chemical mechanism or theory are disclosed, such is provided based on information and belief without necessarily intending to be bound by such. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

1. A process for forming a catalyst for the polymerization of olefins, comprising:
(a) combining a chlorinating agent with a magnesium alkoxide compound to form a magnesium-titanium-alkoxide adduct; and
(b) combining the magnesium-titanium-alkoxide adduct with an alkylchloride compound to form a magnesium chloride support.

2. The process of claim 1, wherein the magnesium alkoxide is formed by reacting a magnesium alkyl with an alcohol generally represented by the formula ROH, wherein R is an alkyl group containing about 1 to 20 carbon atoms.

3. The process of claim 2 wherein the magnesium alkyl is butylethylmagnesium.

4. The process of claim 3, wherein the alcohol is 2-ethyl hexanol.

5. The process of claim 1, wherein the chlorinating agent is generally represented by the formula:
TiClₙ(OR′)₄₋ₙ
wherein R is an alkyl, cycloalkyl, or aryl group, and wherein n is from 1 to 3.

6. The process of claim 5, wherein n is 1.

7. The process of claim 1, wherein the chlorinating agent is ClTi(OⁱPr)₃.

8. The process of claim 4, wherein the chlorinating agent is ClTi(OⁱPr)₃.

9. The process of claim 1, wherein the alkylchloride compound is selected from the group consisting of benzoyl chloride, chloromethyl ethyl ether, and t-butyl chloride.

10. The process of claim 1, wherein the alkylchloride compound is benzoyl chloride.

11. The process of claim 8, wherein the alkylchloride compound is benzoyl chloride.

12. The process of claim 11 wherein the benzoyl chloride/BEM molar ratio is from about 1 to about 20.

13. The process of claim 11 wherein the benzoyl chloride/BEM molar ratio is from about 1 to about 10.

14. The process of claim 11 wherein the benzoyl chloride/BEM molar ratio is from about 4 to about 8.

15. The process of claim 1, wherein the reacting the magnesium-titanium-alkoxide adduct with the alkylchloride compound also forms a by-product selected from the group consisting of an ether compound, an alcohol compound, and mixtures thereof.

16. The process of claim 1, further comprising combining the magnesium chloride support with titanium tetrachloride to form a catalyst.

17. The process of claim 11, further comprising combining the magnesium chloride support with titanium tetrachloride to form a catalyst.

18. The process of claim 16, further comprising washing the magnesium chloride support prior to the contacting the magnesium chloride support with the titanium tetrachloride.

19. The process of claim 17, further comprising washing the magnesium chloride support prior to the contacting the magnesium chloride support with the titanium tetrachloride.

20. A catalyst for polymerizing olefins, the catalyst being formed by a process comprising:
(a) combining a chlorinating agent with a magnesium alkoxide compound to form a magnesium-titanium-alkoxide adduct;
(b) combining the magnesium-titanium-alkoxide adduct with an alkylchloride compound to form a magnesium chloride support; and
(c) combining the magnesium chloride support with titanium tetrachloride to form a catalyst.

21. The catalyst of claim 20, wherein the catalyst has an activity of about 10,000 to about 40,000 g polymer/g catalyst/hour.

22. The catalyst of claim 21, wherein the catalyst consists essentially of agglomerated spheroids having an average particle size (D₅₀) of about 10 to about 30 microns.

23. A polymer produced by combining one or more olefin monomers under reaction conditions suitable for polymerization with a catalyst formed by a process comprising:
(a) combining a chlorinating agent with a magnesium alkoxide compound to form a magnesium-titanium-alkoxide adduct;
(b) combining the magnesium-titanium-alkoxide adduct with an alkylchloride compound to form a magnesium chloride support; and
(c) combining the magnesium chloride support with titanium tetrachloride to form a catalyst.

24. The polymer of claim 23, wherein the polymer is polyethylene having a molecular weight distribution of about 4 to about 10.

25. The polymer of claim 24, wherein the polyethylene has less than about 5 wt. % fines.

26. The polymer of claim 25, wherein the polyethylene has a average particle size (D₅₀) of about 200 to about 800 microns.

27. Film, fiber, pipe, or an article of manufacture comprising the polymer of claim 23.
